(19) United States
(12) Patent Application Publication
(10) Pub. No.: US 2026/0169485 A1
(43) Pub. Date: Jun. 18, 2026

(54) GOLF COURSE GEOFENCE SYSTEM

(71) Applicant: Textron Inc., Providence, RI (US)

(72) Inventor: Preston Sering Easley, Martinez, GA (US)

(73) Assignee: Textron Inc., Providence, RI (US)

(21) Appl. No.: 18/985,317

(22) Filed: Dec. 18, 2024

(51) Int. Cl. G05D 1/617; A01D 34/00; G05D 107/20; G06F 3/04845

(52) U.S. Cl. CPC G05D 1/617; G06F 3/04845; A01D 34/008; G05D 2107/24

(57) ABSTRACT

A golf course management system includes one or more processing circuits configured to provide a graphical user interface on a user device, the graphical user interface including a restricted operation area feature that facilitates establishing one or more restricted operation areas within a respective area based on a user input received from the user device, establish a first restricted operation area around a first area of the respective area, and establish a second restricted operation area around a second area of the respective area, the second restricted operation area surrounding the first restricted operation area. The first restricted operation area or the second restricted operation area is established based on the user input to the user device. The other one of the first restricted operation area or the second restricted operation area is established based on a location of the first restricted operation area or the second restricted operation area.

### BACKGROUND

Golf carts are commonly used by golfers while playing a round of golf to drive between holes, to their ball, and to carry their bags. Other vehicles, such as drink carts, ground maintenance vehicles, recreational vehicles, utility vehicles, etc. are also commonly found at a golf course. Keep-out geofences may be established around areas of the golf course where the golf carts and other vehicles should not drive. These areas may include greens, tee boxes, buildings, water, woods, among others. When the golf cart or the other vehicles drive in the area defined by the keep-out geofence, the operation thereof may be limited.

### SUMMARY

One embodiment relates to a golf course management system. The golf course management system includes one or more processing circuits configured to provide a graphical user interface on a user device, the graphical user interface including a restricted operation area feature that facilitates establishing one or more restricted operation areas within a respective area based on a user input received from the user device, establish a first restricted operation area around a first area of the respective area, and establish a second restricted operation area around a second area of the respective area, the second restricted operation area surrounding the first restricted operation area. The first restricted operation area or the second restricted operation area is established based on the user input to the user device. The other one of the first restricted operation area or the second restricted operation area is established based on a location of the first restricted operation area or the second restricted operation area.

Another embodiment relates to a golf course management system. The golf course management system includes one or more processing circuits configured to provide a graphical user interface on a user device, the graphical user interface including a restricted operation area feature that facilitates establishing a restricted operation area within a respective area based on a user input received from the user device, establish the restricted operation area around a first area of the respective area based on the user input, determine that the restricted operation area is established around or at least partially along a cart path of the respective area, and modify or suggest modifying the restricted operation area such that the restricted operation area does not overlap the cart path.

Still another embodiment relates to a golf course management system. The golf course management system includes one or more processing circuits configured to provide a graphical user interface on a user device, the graphical user interface including a map of a respective area and including a restricted operation area feature that facilitates establishing one or more restricted operation areas on the map based on a user input received from the user device, establish a restricted operation area around a first area of the respective area, determine (i) a location of the restricted operation area and (ii) a location of a drivable area on the map, determine that the restricted operation area overlaps at least a portion of the drivable area based on the location of the restricted operation area relative to the location of the drivable area, and adjust or suggest adjusting a boundary of the restricted operation area to extend along a boundary of the drivable area such that the restricted operation area does not overlap the drivable area.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is another schematic block diagram of the vehicle of FIG. 1, according to an exemplary embodiment.

FIG. 4 is a schematic block diagram of a fleet monitoring and control system including a plurality of the vehicles of FIG. 1, according to an exemplary embodiment.

FIG. 5 is a top view of a golf course including the vehicle of FIG. 1, according to an exemplary embodiment.

FIG. 6 is a top view of a golf course including the vehicle of FIG. 1, according to an exemplary embodiment.

FIG. 7 is a graphical user interface including a geofence establishing menu and a golf course view panel, according to an exemplary embodiment.

FIG. 8 is the graphical user interface of FIG. 7 including a geofence settings menu, according to an exemplary embodiment.

FIG. 9 is the graphical user interface of FIG. 7 including a geofence editor menu, according to an exemplary embodiment.

FIG. 10 is a top view of a golf course including a first geofence and a second geofence surrounding the first geofence, according to an exemplary embodiment.

FIG. 11 is a top view of a golf course including a passthrough geofence along a cart path, according to an exemplary embodiment.

FIG. 12 is a top view of a golf course including a geofence partially overlapping a cart path, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Overall Vehicle

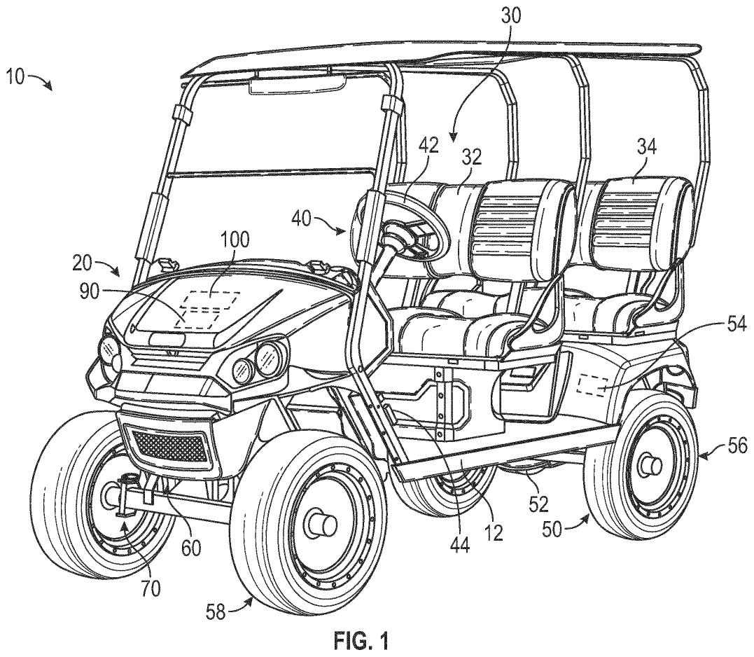

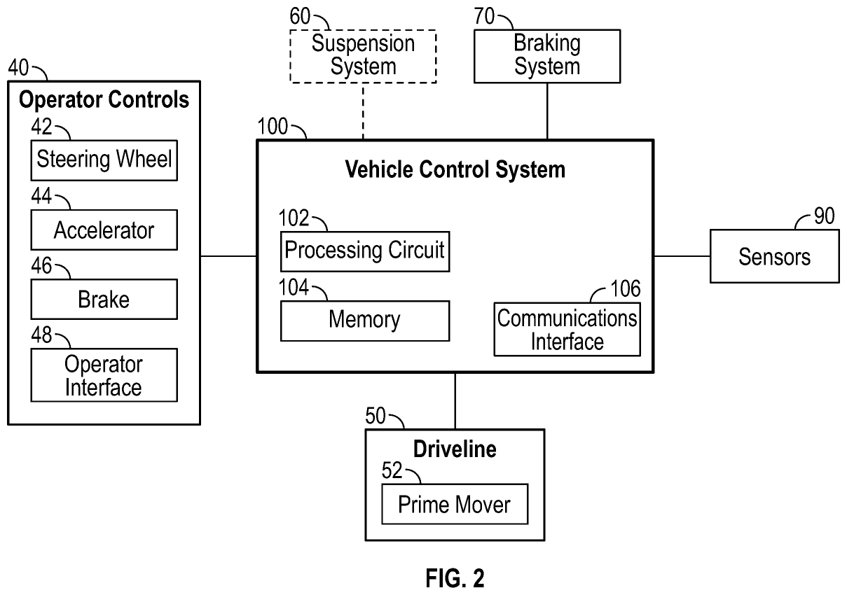

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle control system 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf cart or vehicle, an all-terrain vehicle (“ATV”), a utility task vehicle (“UTV”), a low speed vehicle (“LSV”), a personal transport vehicle (“PTV”), a hauler, a ground support equipment (“GSE”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input devices may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.), shown as rear tractive assembly 56, and a second tractive assembly (e.g., axles, wheels, tracks, differentials, etc.), shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor (e.g., the motor 53) and the energy storage 54 is a battery system (e.g., the battery module 57, the add-on battery module(s) 59, etc.). In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements. In some embodiments, electric regenerative braking is employed (e.g., via the prime mover 52, an electric motor, etc.) in combination with or instead of using the braking system 70 to facilitate braking of one or more components of the driveline 50.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, a Doppler sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle control system 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle control system 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle control system 100 may represent a collection of processing devices. In such cases, the processing circuit 102 represents the collective processors of the devices, and the memory 104 represents the collective storage devices of the devices.

In one embodiment, the vehicle control system 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle control system 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle control system 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Electrified Driveline

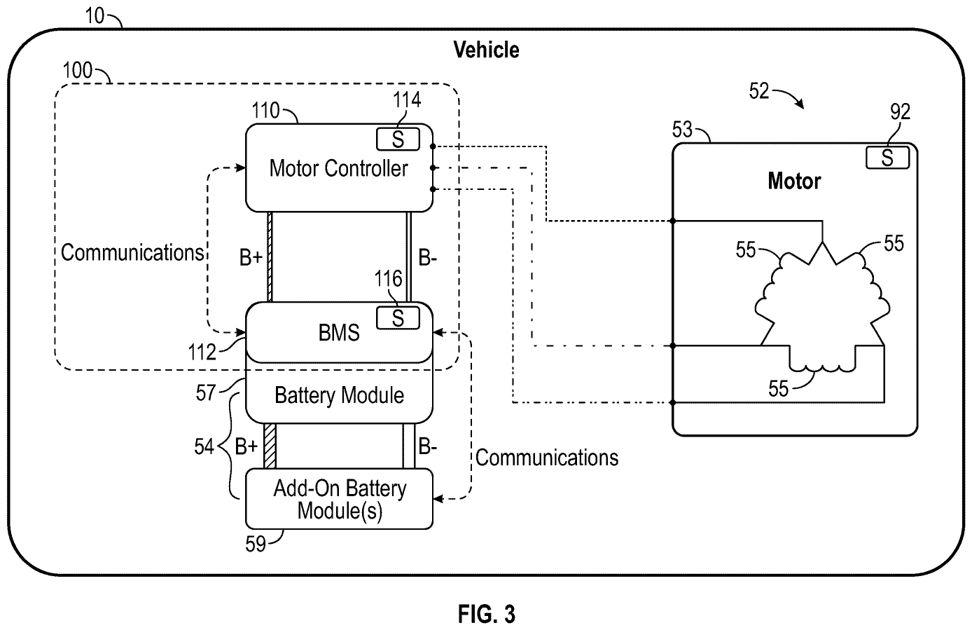

According to the exemplary embodiments shown in FIG. 3, the driveline 50 of the vehicle 10 is configured as an electrified driveline where (a) the prime mover 52 is configured as a three-phase, alternating current (“AC”) electric motor, shown as motor 53, including three sets of windings, shown as motor windings 55, and a first sensor, shown as motor sensor 92; (b) the energy storage 54 is configured as a battery system including a first battery pack or module, shown as battery module 57, and one or more second battery packs or modules, shown as add-on battery module(s) 59, electrically coupled to the battery module 57 in parallel; and (c) the vehicle control system 100 includes (i) a first controller, shown as motor controller 110, coupled to the motor 53 and including a second sensor, shown as motor controller sensor 114, and (ii) a second controller, shown as battery management system (“BMS”) 112, coupled to the motor controller 110 and the energy storage 54 (e.g., the battery system, the battery module 57, the add-on battery module(s) 59, etc.) and including a third sensor, shown as BMS sensor 116. In some embodiments, the motor 53 is configured as a separately excited DC motor. The motor sensor 92, the motor controller sensor 114, and/or the BMS sensor 116 may include a temperature sensor, a voltage sensor, a current sensor, a speed sensor, and/or another suitable sensor to facilitate monitoring at least one of the operational parameters (e.g., temperature, voltage, current, speed, SOC, rate of charge, rate of discharge, etc.) of the motor 53, the motor controller 110, the BMS 112, the battery module 57, and/or the add-on battery modules(s) 59. The motor controller 110 and the BMS 112 may each include a processing circuit 102, a memory 104, and a communications interface 106.

According to an exemplary embodiment, each of the battery module 57 and the add-on battery module(s) 59 of the battery system includes one or more rows and/or groups of battery cells. The BMS 112 may be configured to monitor characteristics of the rows and/or groups of battery cells and/or individual cells of the battery module 57 and the add-on battery module(s) 59 (e.g., using data acquired by the BMS sensor 116) including, but not limited to, voltage, temperature, current, and state of charge (“SOC”). The BMS 112 may also be configured to provide direct current (“DC”) power from the battery system to the motor controller 110 to power the motor 53 based on driving demands of the vehicle 10.

According to an exemplary embodiment, the motor controller 110 is configured to manage the power supplied to the motor 53. By way of example, the motor controller 110 may be configured to modulate the voltage, current, phase, and/or frequency of the power sent to the motor windings 55, which can influence the torque and speed output provided by the motor 53. In some embodiments, the motor controller 110 is configured to control a type of power, AC power or DC power, delivered to the motor 53. By way of example, the motor controller 110 may be configured to convert the type of power from DC power to AC power and/or regulate the AC power or DC power depending on the intended function of the motor 53. The motor controller 110 may include components to invert, convert, or otherwise modulate DC power and/or AC power.

As shown in FIG. 3, the energy storage 54 is configured to supply (e.g., via electrical wiring, electrical connections, etc.) DC power to the motor controller 110. In some embodiments, the DC power flows from the energy storage 54, through the BMS 112, and to the motor controller 110. The BMS 112 and the motor controller 110 may include communication interfaces (e.g., communications interfaces 106) that facilitate exchanging data related to operational status, command signals, and feedback therebetween. The BMS 112 and the add-on battery module 59 (e.g., a BMS thereof) may include communication interfaces that facilitate exchanging data related to operational status, command signals, and feedback therebetween. The add-on battery module(s) 59 is(are) configured to provide additional battery cells and increase the total energy storage capacity of the energy storage 54. As shown in FIG. 3, the battery module 57 and the add-on battery module(s) 59 are connected in parallel (e.g., via wires, connection busses, etc.) to provide for a pathway of electrical transfer. In other embodiments, the battery module 57 and the add-on battery module(s) 59 are connected in series.

According to an exemplary embodiment, the BMS 112 is configured to monitor (e.g., continuously, periodically, etc.) various parameters of the energy storage 54, including voltage, current, and temperature of each cell, rows/groups, and/or module within the energy storage 54. In some embodiments, the BMS 112 is configured to calculate or otherwise determine the SOC of the energy storage 54, the battery module 57, and/or the add-on battery module(s) 59. In some embodiments, the BMS 112 is configured to redistribute charge among the cells, rows/groups, and/or the modules to ensure an equal or substantially equal charge level throughout the energy storage 54. The BMS 112 can communicate with other systems or components or the vehicle 10 or with external devices (e.g., the remote systems 240) to report on battery status and diagnostics and/or to receive control commands.

According to an exemplary embodiment, the BMS 112 is configured to detect faults or failures in the energy storage 54 that may potentially lead to or that have caused an overcharge condition and, thereby, a thermal runaway event. By way of example, the BMS 112 may be configured to monitor the voltage of individual cells, rows/groups, or modules of the energy storage 54, and when deviations from normal voltage levels occur beyond a nominal range, the BMS 112 may determine that a fault or failure is present and that there is a potential for an overcharge condition or that there is an actual overcharge condition. In some implementations, the BMS 112 is configured to detect voltage imbalance or voltage imbalance trends. By way of another example, the BMS 112 may additionally or alternatively be configured to monitor current flows during charging and discharging of the energy storage 54 and identify unexpected fluctuations in current that may indicate that a fault or failure is present and that there is a potential for an overcharge condition or that there is an actual overcharge condition. By way of still another example, the BMS 112 may additionally or alternatively be configured to monitor the temperature of the cells, rows/groups, and/or modules of the energy storage 54 and identify anomalously high temperatures that may indicate that a fault or failure is present and that there is a potential for an overcharge condition or that there is an actual overcharge condition. It should be understood that the above example of detecting faults, failures, or overcharge conditions is provided for example purposes only and is not exhaustive. Other methods or techniques may be implemented to detect faults, failures, or overcharge conditions, which are intended to be included within the scope of the present disclosure. Additional details regarding fault detection regarding the energy storage 54 is described in greater detail herein. Further details regarding fault detection, including voltage imbalance, may be found in U.S. patent application Ser. No. 18/884,363, filed Sep. 13, 2024, which is incorporated herein by reference in its entirety.

### Fleet Monitoring and Control System

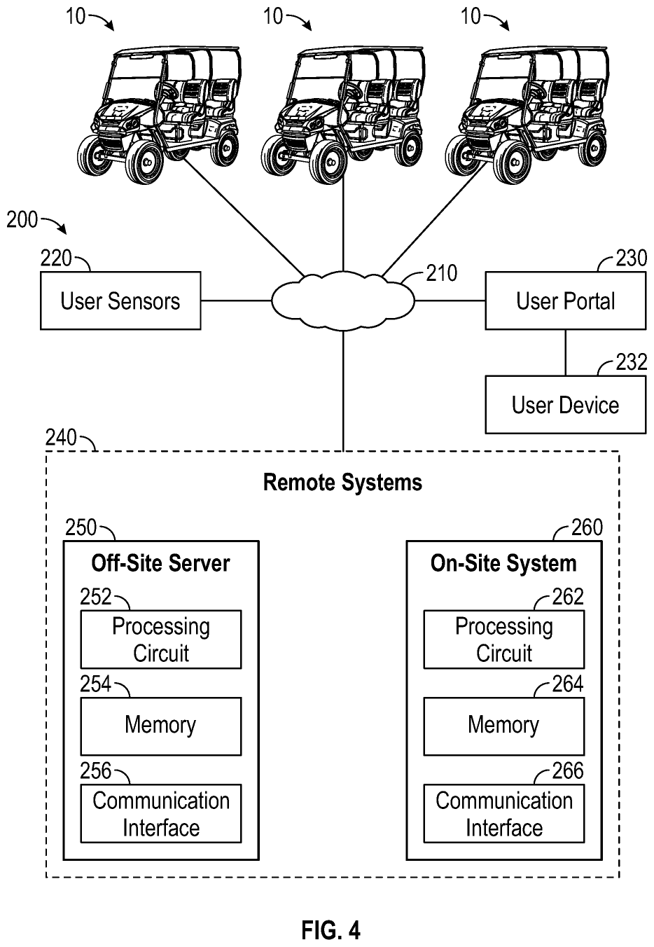

As shown in FIG. 4, a site monitoring and control system, shown as fleet monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210. In some embodiments, the fleet monitoring and control system 200 does not includes the user portal 230 and/or the user device 232.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, a heart rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons breaking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 4, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 4, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 4, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle control systems 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Geofence Shaping

According to an exemplary embodiment, the fleet monitoring and control system 200, including the vehicle control system 100, the user sensors 220, the user portal 230, and the remote systems 240, is configured to facilitate improving or enhancing location detection of the vehicles 10 and associated control thereof based on location. Further, it should be understood that any of the functions or processes described herein with respect to the fleet monitoring and control system 200 may be performed by the vehicle control system 100 and/or the remote systems 240. By way of example, data collection may be performed by the vehicle control system 100 and data analytics may be performed by the vehicle control system 100. By way of another example, data collection may be performed by the vehicle control system 100 and data analytics may be performed by the remote systems 240. By way of yet another example, data collection may be performed by the vehicle control system 100, a first portion of data analytics may be performed by the vehicle control system 100, and a second portion of data analytics may be performed by the remote systems 240. By way of still another example, a first portion of data collection may be performed by the vehicle control system 100, a second portion of data collection may be performed by the remote systems 240, and data analytics may be performed by the vehicle control system 100 and/or the remote systems 240.

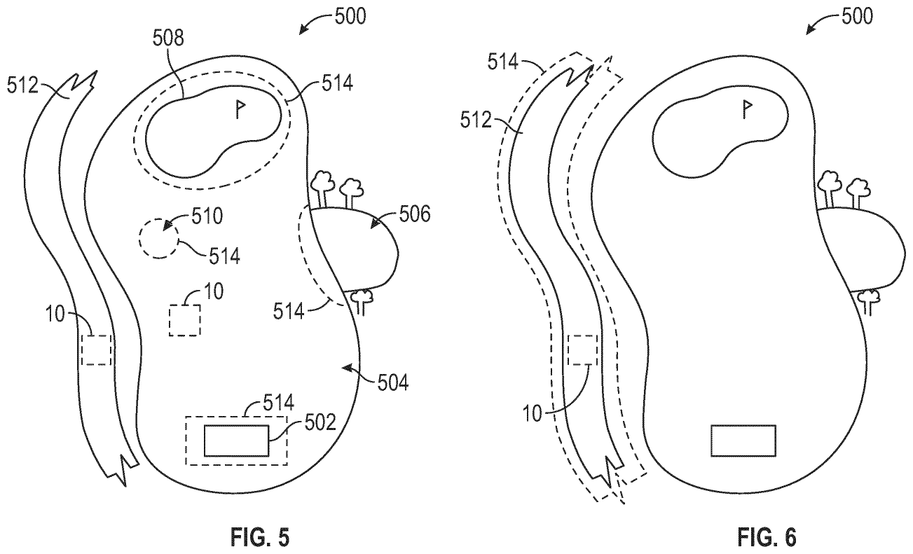

As shown in FIGS. 5 and 6, the vehicle 10 may be a golf cart driven by an operator playing golf on a golf course 500. In some embodiments, the vehicle 10 is a drink cart, a cart driven by an employee of the golf course 500 monitoring the pace of play of golfers, a cart driven by the maintenance crew working at the golf course 500, or another type of vehicle or vehicle commonly found at golf courses (e.g., a turf mower, a sprayer, an aerator, a bunker rake, etc.). A hole of the golf course 500 is shown including a tee box 502; a fairway 504; a water hazard, woods, fescue, etc., shown as out-of-bounds area 506; a putting green, shown as green 508; an area in the fairway 504 that is under repair, a non-playable area, etc., shown as hazard 510; and a path, a trail, a cart route, etc., shown as cart path 512.

The golf course 500 includes areas that should not be driven on, in, or around by the vehicle 10. By way of example, these areas may include the tee box 502, the out-of-bounds area 506, the fairway 504 during certain conditions (e.g., rain, flooding, under repair, etc.), the green 508, the hazard 510, private property along the golf course 500, a club house of the golf course 500, roped-off areas, dry/brown grass areas, areas with new sod, and/or another areas of the golf course 500. Driving on, in, or around these areas by the vehicle 10 may damage the golf course 500, be dangerous for an operator of the vehicle 10, damage the vehicle 10, be illegal (e.g., trespassing on private property), etc. Collectively, these areas are hereinafter referred to as restricted areas. Accordingly, one or more geofences (e.g., a virtual boundary, a virtual fence, etc.), shown as geofences 514, may be established around the restricted areas. The geofences 514 may be areas or boundaries defined around the restricted areas to control and manage the operation of the vehicle 10 on the golf course 500. By way of example, when the vehicle 10 is driven beyond the virtual boundary of the geofence 514 (i.e., driven into a restricted area), the operation of the prime mover 52 of the vehicle 10 may be limited (e.g., limit speeds below a speed threshold such as below 5 miles per hour, prevent forward travel of the vehicle 10, limit the vehicle 10 to backward travel only, disabled, limited or restricted operation, etc.). Areas of the golf course 500, such as the cart path 512, a parking lot of the golf course 500, the fairway 504, a cart return area, etc. that are not restricted areas defined by a geofence 514 may be drivable (e.g., navigable, permitted, unrestricted operation, etc.) by the vehicle 10, and are hereinafter referred to as the drivable areas. In some embodiments, a cart path only rule may be implemented where the vehicle 10 is supposed to drive on the cart path 512 only (e.g., after or during heavy rainfall). In such an embodiment, the geofence 514 may be established everywhere except for the cart path 512.

As shown in FIG. 6, the geofence 514 is established around the cart path 512. The geofence 514 formed around the cart path 512 may facilitate implementing the cart path only rule where the vehicle 10 is supposed to drive on the cart path 512 only (e.g., after or during heavy rainfall, to avoid ground under repair, when the cart path 512 is a bridge crossing a river/pond, etc.). As shown in FIG. 6, rather than defining geofences 514 around the restricted areas (i.e., everywhere but the cart path 512), a geofence 514 (e.g., a cart path geofence) is formed around the cart path 512. By way of example, when the vehicle 10 is driven beyond the virtual boundary of the geofence 514 (i.e., driven off of the cart path 512 and into a restricted area), the operation of the prime mover 52 of the vehicle 10 may be limited (e.g., limit speeds below a speed threshold such as below 5 miles per hour, prevent forward travel of the vehicle 10, limit the vehicle 10 to backward travel only, disabled, limited or restricted operation, etc.). In some embodiments, the geofences 514 are established around the restricted areas (as shown in FIG. 5) and around the drivable areas (e.g., around the cart path 512 as shown in FIG. 6).

According to an exemplary embodiment, a location of the vehicle 10 is monitored by the fleet monitoring and control system 200 to determine the location of the vehicle 10 relative to the geofence 514, the restricted areas, and the drivable areas. The location of the vehicle 10 may be determined based on GPS data (e.g., collected by the sensors 92 and/or the user sensors 220). The fleet monitoring and control system 200 may be configured to store the location data and analyze the location data to make operational decisions based thereon.

In some embodiments, a true location (e.g., real-time position, actual location, etc.) of the vehicle 10 is different than a tracked location of the vehicle 10 determined based on the GPS data. The error or difference between the tracked location of the vehicle 10 and the true location of the vehicle 10 may be caused by signal interference (e.g., geomagnetic radiation), solar storms, signal obstruction (e.g., tree cover, building cover, etc.), weather (e.g., rain, snow, pressure, etc.), control system quality, malfunctioning sensors, and/or any other combination of internal hardware or external factors. The difference between the tracked location and the true location may be referred to herein as location or GPS drift. Because of the difference between the tracked location and the true location, the fleet monitoring and control system 200 may determine, based on the GPS position, that the vehicle 10 is operating in the restricted area (e.g., near/on a green or tee box, near/on a hazard such as ground under repair, an area defined by a geofence, a non-drivable area, etc.) when in reality, the true location of the vehicle 10 is not in the restricted area. In such an example, the fleet monitoring and control system 200 may undesirably limit the operation of the vehicle 10. Similarly, because of the difference between the tracked location and the true location, the fleet monitoring and control system 200 may determine, based on the GPS position, that the vehicle 10 is not operating in the restricted area (e.g., operating in the drivable area) when in reality, the true location of the vehicle 10 is in the restricted area. In such an example, the fleet monitoring and control system 200 may undesirably permit operation of the vehicle 10 within the restricted area.

According to an exemplary embodiment, the fleet monitoring and control system 200 is configured to correct (e.g., adjust for, account for, etc.) the undesirable controlling of the operation of the vehicles 10 as a result of the GPS drift. By way of example, the fleet monitoring and control system 200 may be configured to force the tracked location to be within the drivable area in response to a determination, based on the true location, that the vehicle 10 is traveling in the drivable area and the tracked location indicates that the vehicle 10 is in the restricted area. By way of another example, the fleet monitoring and control system 200 maybe configured to force the tracked location to be within the restricted area in response to a determination, based on the true location, that the vehicle 10 is traveling in the restricted area and the tracked location indicates that the vehicle 10 is in the drivable area. By way of another example, the fleet monitoring and control system 200 may be configured to control operation of the vehicle 10 based on a corrective position determined using RTK information. In such an example, the corrective position may be based on corrective position data determined based on (i) communications between the on-site system 260 and a satellite (e.g., a global navigation satellite system (GNSS) satellite) and (ii) a known, fixed location of the on-site system 260. By way of yet another example, the fleet monitoring and control system 200 may be configured to control operation of the vehicle 10 based on the type of surface the vehicle 10 is driving on. In some embodiments, when a determination is made that the true location is different than the tracked location (e.g., the coordinates are different), the fleet monitoring and control system 200 may be configured to recalibrate (e.g., reset) the sensors 90 collecting the GPS data and/or send a signal commanding the user sensors 220 to recalibrate.

The fleet monitoring and control system 200 may control an operation of the operator controls 40, the driveline 50, the suspension system 60, the braking system 70, and/or any other component of the vehicle 10 based on the true location (e.g., a corrected position, an actual location, etc.) of the vehicle 10 relative to the restricted areas and the drivable areas. By way of example, the fleet monitoring and control system 200 may determine, based on the true location, that the vehicle 10 is operating (e.g., driving forward, driving backward, idling, stopped, parked, etc.) (i) in a drivable area defined by a respective geofence 514, (ii) near a respective geofence 514 (e.g., within 5 yards of the respective geofence 514, within 10 yards of the respective geofence 514, etc.), or (iii) in a restricted area defined by a respective geofence 514. In response to a determination that the vehicle 10 is operating in a drivable area, the fleet monitoring and control system 200 may facilitate (e.g., permit operation of the vehicle 10 in a first mode of operation) normal or unrestricted operation of the operator controls 40, the driveline 50, the suspension system 60, the braking system 70, and/or any other component of the vehicle 10. In response to a determination that the vehicle 10 is operating in or near a restricted area (e.g., near or in the geofence 514), the fleet monitoring and control system 200 may (i) limit operation (e.g., limit operation of the vehicle 10 in a second mode of operation) of the operator controls 40, the driveline 50, the suspension system 60, the braking system 70, and/or any other component of the vehicle 10 and/or (ii) provide an alert (e.g., visually or audibly via the operator interface 48, in a tactile manner by shaking the steering wheel 42, etc.) to the operator of the vehicle 10 indicative of the location of the restricted area (e.g., a boundary of the geofence 514). By way of example, the monitoring and control system 200 may limit operation of the prime mover 52 such that the vehicle 10 (i) cannot exceed a threshold speed (e.g., 5 miles per hour, 2 miles per hour, etc.), (ii) is limited to rearward travel, and/or (iii) any other control to limit operation of the vehicle 10. In such an example, to transition the vehicle 10 to the second mode of operation, the fleet monitoring and control system 200 may (i) shift the vehicle 10 into neutral (e.g., such that no power is transmitted to the prime mover 52) and/or (ii) operate the braking system 70 to slow the vehicle 10 to a stop. The vehicle 10 may be limited to the second mode of operation until the vehicle 10 navigates (e.g., is navigated by an operator) to the drivable area.

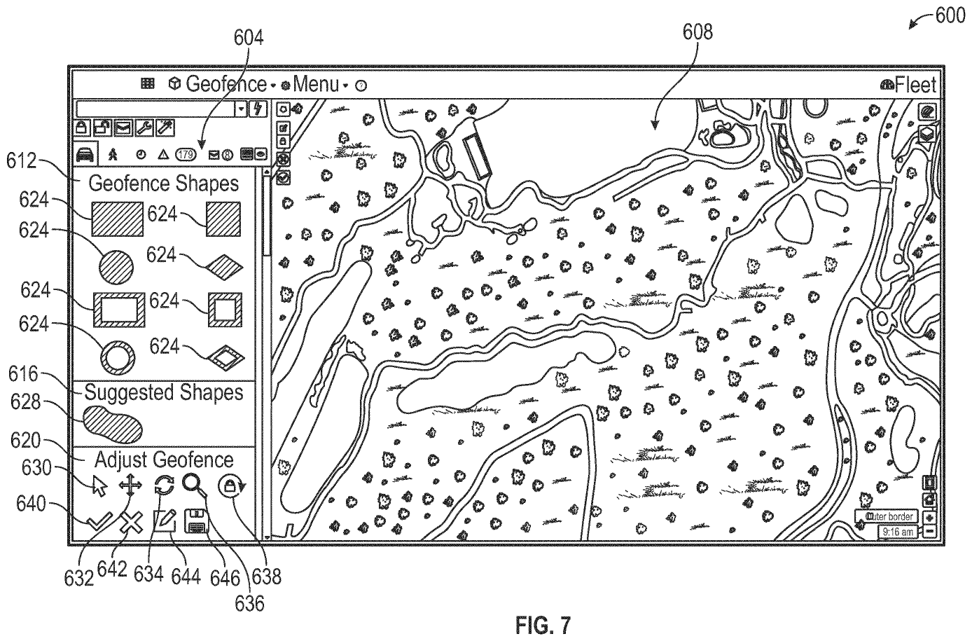

As shown in FIGS. 7-9, a graphical user interface (“GUI”), shown as geofence GUI 600, is configured to provide one or more views, menus, buttons, etc., to facilitate establishing, shaping, and configuring the settings of one or more of the geofences 514 around the restricted areas and/or the drivable areas of the golf course 500. The geofence GUI 600 is configured to be provided to the operator interface 48 and/or the user device 232 for display on the one or more displays thereof. The operator interface 48 and/or the user device 232 are configured to receive an input from the user to provide the user with the ability to control one or more functions of and/or provide commands to the geofence GUI 600 and the fleet monitoring and control system 200. By way of, the user may interact with (e.g., engage with, provide an input to, etc.) the geofence GUI 600 via the operator interface 48 and/or the user device 232 to cause the geofence GUI 600 to display one or more additional elements, menus, panels, etc.

As shown in FIG. 7, the geofence GUI 600 includes a geofence shaping and adjustment menu (e.g., restricted operation area feature), shown as geofence establishing menu 604, and a golf course information panel (e.g., a hole view panel, a hole information panel, a course view panel, etc.), shown as golf course view panel 608. According to an exemplary embodiment, the geofence establishing menu 604 is configured to provide the user with the ability to establish the geofences 514 on the golf course 500 around the restricted areas and/or the drivable areas. Establishing a geofence 514 as discussed herein may include creating a new geofence 514, selecting and editing a shape of the geofence 514 (e.g., a new geofence 514 and a previously created geofence 514), selecting and editing a size of the geofence 514, and/or moving (e.g., translating, rotating, etc.) the geofence 514 about the golf course 500, among other controls relating to establishing the geofence 514.

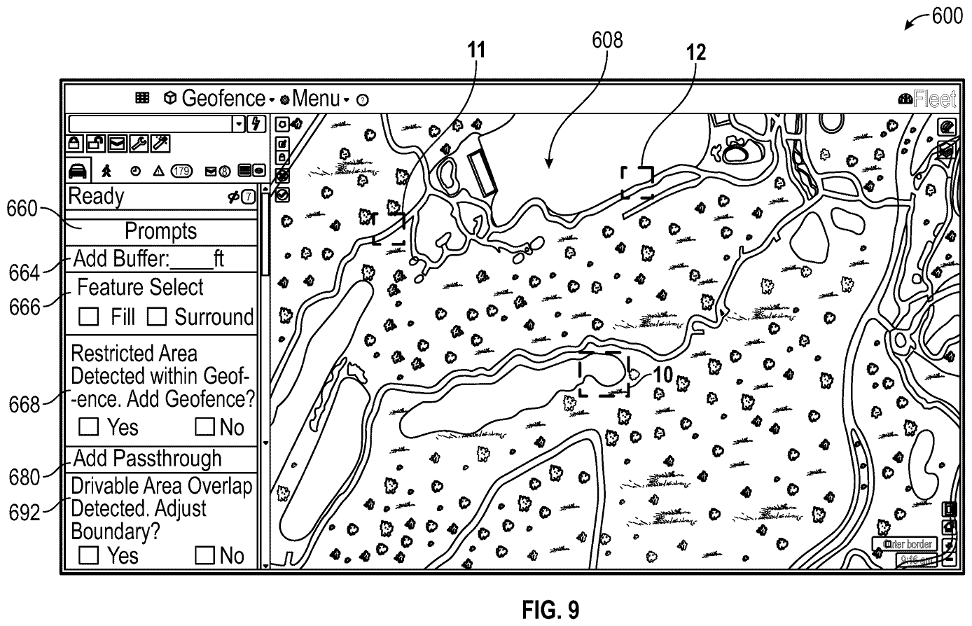

As shown in FIGS. 7 and 9, the golf course view panel 608 includes a map of the golf course 500. The golf course view panel 608 is configured to display (a) the tee box 502, the fairway 504, the out-of-bounds area 506, the green 508, the hazard 510, etc. of one or more holes, (b) the cart path 512, and (c) any other features of the golf course 500. The user may interact with the golf course view panel 608 to zoom in to view a particular area of the golf course 500, zoom out to view a larger area of the golf course 500, pan across the map to view different areas of the golf course 500, rotate the map, and/or otherwise interact with the golf course view panel 608 to manipulate a view of the golf course 500 displayed by the golf course view panel 608. In some embodiments, the user provides an input to the golf course view panel 608 specifying a respective hole of the golf course 500, and the golf course view panel 608 is configured to display the respective hole. In some embodiments, the golf course view panel 608 is configured to display real-time updates regarding the locations of the vehicles 10 on the golf course 500.

As shown in FIG. 7, the geofence establishing menu 604 includes a shape panel, shown as geofence shape panel 612, a suggested shape pane, shown as suggested geofence shape panel 616, and an adjustment panel, shown as geofence adjustment panel 620. The geofence shape panel 612 includes a plurality of shape elements, shown as shape elements 624, of predefined geofence shapes. The shape elements 624 may include a rectangular geofence shape, a square geofence shape, a circular geofence shape, a diamond geofence shape, an outline of a rectangle geofence shape, an outline of a square geofence shape, an outline of a circle geofence shape, an outline of a diamond geofence shape, or any other suitable geofence shape (e.g., triangular, ovular, quadrilateral, hexagonal, polygonal, curvilinear, freeform, annulus, etc.) or outline of a geofence shape. In some embodiments, the user selects a shape element 624 to establish a geofence 514 with a respective shape corresponding to the selected shape element 624. By way of example, the user may select the shape element 624 associated with the square geofence shape to establish a geofence 514 with a square shape.

As shown in FIG. 7, the suggested geofence shape panel 616 includes one or more suggested shape elements, shown as suggested shape elements 628. The suggested shape elements 628 include one or more geofence shapes suggested by the fleet monitoring and control system 200. In some embodiments, the suggested shape elements 628 include geofence shapes suggested by the fleet monitoring and control system 200 based on a selected location for the geofence 514. By way of example, the user may provide an input to the golf course view panel 608 indicating a location (e.g., the tee box 502, the fairway 504, the out-of-bounds area 506, the green 508, the hazard 510, the cart path 512, etc.) of where the geofence 514 is to be established (e.g., where the user wishes to establish the geofence 514), and the fleet monitoring and control system 200 may generate and suggest, based on the location, the suggested shape elements 628 with geofence shapes corresponding to (e.g., matching a shape and size of) the location. In some embodiments, the suggested shape elements 628 include geofence shapes suggested by the fleet monitoring and control system 200 based on previously selected (e.g., previously drawn, previously suggested, etc.) geofence shapes. By way of example, the fleet monitoring and control system 200 may generate and suggest the suggested shape elements 628 with geofence shapes that were previously selected and used to establish other geofences 514.

In some embodiments, in addition or as an alternative to selecting the shape elements 624 or the suggested shape elements 628 to define a shape of the geofence 514, the user can provide one or more inputs to the golf course view panel 608 create a shape of the geofence 514. By way of example, the user may draw a boundary of the geofence 514 to create the geofence 514. In such an example, the shape of the geofence 514 drawn by the user may correspond to a shape of the restricted area or the drivable area around which the geofence 514 is established.

In some embodiments, the user provides an input to the golf course view panel 608 indicating a respective location (e.g., a restricted area, a drivable area, the tee box 502, the fairway 504, the out-of-bounds area 506, the green 508, the hazard 510, the cart path 512, etc.) on the golf course 500 of where the geofence 514 is to be established (e.g., where the user wishes to establish the geofence 514). In such embodiments, the user then selects a geofence shape (e.g., from the shape elements 624 or the suggested shape elements 628) and the fleet monitoring and control system 200 automatically establishes the geofence 514 defining the selected geofence shape around the respective location. In other embodiments, the user first selects a geofence shape, then selects a respective location on the golf course 500 displayed by the golf course view panel 608 to establish the geofence 514 defining the selected geofence shape at the respective location. In still other embodiments, the user provides an input to the geofence shape panel 612 or the suggested geofence shape panel 616 to select a geofence shape from the shape elements 624 or the suggested shape elements 628, respectively, and drags the selected geofence shape to the golf course view panel 608 to a desired location on the golf course 500 displayed by the golf course view panel 608. In some embodiments, the golf course view panel 608 is configured to display an indication of the locations of the geofences 514 established on the golf course 500.

According to an exemplary embodiment, the geofence adjustment panel 620 includes a plurality of elements configured to facilitate adjusting the geofence 514 (e.g., an established geofence 514). As shown in FIG. 7, the geofence adjustment panel 620 includes a first element, shown as select button 630, configured to provide the user with the ability to select one or more geofences 514 on the golf course view panel 608; a second element, shown as pan button 632, configured to provide the user with the ability to drag and move the map of the golf course 500 and/or a geofence 514 displayed by the golf course view panel 608 (e.g., drag and move the entire geofence 514, drag and move a portion (e.g., corners, control points, Bezier handles, etc.) of the geofence 514, etc.); a third element, shown as rotate button 634, configured to provide the user with the ability to rotate the map of the golf course 500 and/or a geofence 514 displayed by the golf course view panel 608; a fourth element, shown as zoom button 636, configured to provide the user with the ability to zoom in on or zoom out of the map of the golf course 500 displayed by the golf course view panel 608 or with the ability to enlarge or shrink the size of the geofence 514; a fifth element, shown as lock button 638, configured to provide the user with the ability to lock the geofence 514 such that the geofence 514 is not unintentionally (e.g., inadvertently) edited (e.g., moved, rotated, resized, reshaped, etc.); a sixth element, shown as confirm button 640, configured to provide the user with the ability to confirm edits made to the geofence 514 after editing the geofence 514; a seventh element, shown as cancel button 642, configured to provide the user with the ability to discard the edits made to the geofence 514 or delete the geofence 514; an eighth element, shown as edit button 644, configured to provide the user with the ability to edit the geofence 514; and a ninth element, shown as save button 646, configured to provide the user with the ability to save the edits made to the geofence 514 (e.g., to the memory 104, the memory 254, and/or the memory 264). In some embodiments, the geofence adjustment panel 620 includes more or fewer elements than shown in FIG. 7. The inputs to the geofence establishing menu 604 (e.g., the establishment of new geofences 514, the edits made to existing geofences 514, etc.) may update the configuration (e.g., the display) of the golf course view panel 608, and may be transmitted to the fleet monitoring and control system 200 such that the newly established geofences 514 and/or the edits (e.g., new boundaries, sizes, shapes, etc.) to existing geofences 514 are enforced by the fleet monitoring and control system 200.

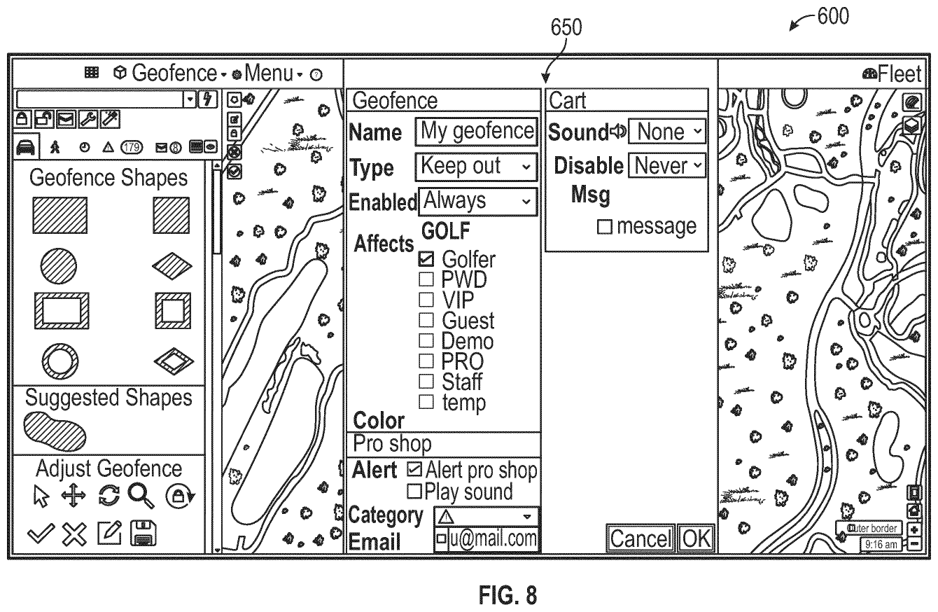

As shown in FIG. 8, the geofence GUI 600 is configured to display a settings menu, shown as geofence settings menu 650, configured to provide the user with the ability to configure settings of the geofences 514. In some embodiments, the geofence settings menu 650 is displayed in response to an input by the user to establish a geofence 514. In other embodiments, the geofence settings menu 650 is displayed in response to an input by the user to the edit button 644. In some embodiments, inputs to the geofence settings menu 650 update settings to a plurality of geofences 514. By way of example, the user may select a plurality of geofences 514 using the select button 630 and may provide inputs to the geofence settings menu 650 to update the settings of each of the selected geofences 514.

As shown in FIG. 8, the settings associated with a geofence 514 and configurable via the geofence settings menu 650 include a name of the geofence 514, a type of the geofence 514, a geofence schedule, and a type of the vehicle 10 that the geofence 514 affects. The geofence 514 may be named based on the type of the geofence 514, the location of the geofence 514, or named for any other reason. The type of the geofence 514 may include a keep-out geofence, a keep-in geofence (e.g., a cart path only geofence), an advertisement geofence, a message geofence, or another type of geofence.

According to an exemplary embodiment, as a keep-out geofence, the fleet monitoring and control system 200 may limit operation of the vehicle 10 in the second mode of operation when the location indicates that the vehicle 10 is in the area (e.g., the restricted area) defined by the keep-out geofence. As a keep-in geofence, the fleet monitoring and control system 200 may (i) permit unrestricted operation of the vehicle 10 when the location indicates that the vehicle 10 is in the area (e.g., the drivable area) defined by the keep-in geofence and (ii) limit operation of the vehicle 10 in the second mode of operation when the location indicates that the vehicle 10 is outside of the area (e.g., in the restricted area) defined by the keep-in geofence. As an advertisement geofence, the fleet monitoring and control system 200 may provide an advertisement (e.g., a picture, a video, an audio file, etc.) to the operator interface 48 and the occupants within the vehicle 10 when the location indicates that the vehicle 10 is in the area defined by the advertisement geofence. As a message geofence, the fleet monitoring and control system 200 may provide a message (e.g., a text alert, a video alert, an audio alert, etc.) to the operator interface 48 and the occupants within the vehicle 10 when the location indicates that the vehicle 10 is in the area defined by the message geofence.

The geofence settings menu 650 may be configured to provide the user with the ability to set a schedule of when the geofences 514 are enabled by the fleet monitoring and control system 200. By way of example, during the hours of operation of the golf course 500, the geofences 514 established throughout the golf course 500 may operate normally (e.g., permitting or limiting operation of the vehicle 10, providing an advertisement, providing messages, etc., based on respective configurations of respective geofences 514) as discussed above with respect to FIGS. 5 and 6. By way of another example, outside the hours of operation of the golf course 500, the geofences 514 established throughout the golf course 500 may transition to define restricted areas such that operation of the vehicle 10 is only permitted in the drivable areas. By way of yet another example, outside the hours of operation of the golf course 500, a geofence 514 defining a restricted area may be established around the entire golf course 500 such that operation of all vehicles 10 on the golf course 500 is disabled (e.g., inoperable).

The geofence settings menu 650 may be configured to provide the user with the ability to set the type of the vehicle 10 that the geofence 514 affects. In other words, (i) the operation of the vehicle 10 may be permitted or limited or (ii) the advertisement and/or message may or may not be provided to the vehicle 10 depending on the type of the vehicle 10. By way of example, a first vehicle type may be permitted to operate in the first mode of operation responsive to crossing into a respective geofence 514 and a second vehicle type may be limited to the second mode of operation responsive to crossing the same respective geofence 514. In such an example, a vehicle 10 configured as a lawnmower configured to cut the grass on the green 508 (i.e., a vehicle 10 of the first vehicle type) may be permitted to operate in the first mode of operation, while a golf cart driven by a golfer (i.e., a vehicle 10 of the second vehicle type) may be limited to the second mode of operation responsive to crossing the same respective geofence 514 (e.g., to prevent certain types of vehicles 10 from operating in certain areas). By way of another example, a first vehicle type may not receive the advertisement responsive to crossing into a respective geofence 514 and a second vehicle type may receive the advertisement responsive to crossing the same respective geofence 514. In such an example, a vehicle 10 configured as a drink cart, a cart driven by an employee of the golf course 500 monitoring the pace of play of golfers, a cart driven by the maintenance crew working at the golf course 500, a lawnmower, a turf mower, a push mower, a ride-on mower, a stand-on mower, aerator, turf sprayers, bunker rake, and/or another type of chore product (i.e., a vehicle 10 of the first vehicle type) may not receive the advertisement, while a golf cart driven by a golfer (i.e., a vehicle 10 of the second vehicle type) may receive the advertisement responsive to crossing the same respective geofence 514.

The geofence settings menu 650 may be configured to provide the user with the ability to set a credential level of the operator of the vehicle 10 the geofence 514 affects. In other words, (i) the operation of the vehicle 10 may be permitted or limited or (ii) the advertisement and/or message may or may not be provided to the vehicle 10 depending on the credentials associated with the vehicle 10 and/or the credentials of the operator of the vehicle 10 (e.g., thereby selectively restricting access to certain areas of the golf course 500, thereby selectively advertising to golfers, etc.). By way of example, responsive to crossing into a geofence 514, (i) the vehicle 10 may be operable in the first mode of operation (or limited to the second mode of operation) if the operator (e.g., an employee) of the vehicle 10 is authorized to enter the area defined by the geofence 514 or (ii) the vehicle 10 may be limited to the second mode of operation (or a mode of operation more restrictive than the second mode of operation) if the operator (e.g., a golfer) of the vehicle 10 is not authorized to enter the area defined by the geofence 514.

As shown in FIG. 8, the geofence settings menu 650 is configured to provide the user with the ability to select whether to provide an alert in response to the vehicle 10 crossing into a respective geofence 514. In some embodiments, the alert includes a visual or audible alert provided to the operator of the vehicle 10 via the operator interface 48, or a haptic alert provided to the operator of the vehicle 10 in a tactile manner by shaking the steering wheel 42 or their seat. In some embodiments, the alert includes a visual or audible alert provided to the on-site system 260 (e.g., to a user such as an employee at a clubhouse of the golf course 500). In some embodiments, the geofence settings menu 650 includes one or more additional features to provide the user with the ability to configure one or more additional settings of the vehicle 10 and/or the geofence 514.

As shown in FIG. 9, the geofence GUI 600 is configured to display a geofence tool menu, shown as geofence editor menu 660, configured to provide the user with the ability to further edit existing geofences 514 (e.g., beyond the editing features provided by the geofence adjustment panel 620) and/or establish new geofences 514 based on existing geofences 514. As shown in FIG. 9, the geofence editor menu 660 includes a buffer element, shown as geofence buffer element 664, configured to facilitate increasing a size or decreasing a size of a respective geofence 514 according to an input to the geofence buffer element 664. The buffer may be added to the geofence 514 (i) symmetrically such that the size increase or decrease of the geofence 514 is the same at any point along the geofence 514 where the buffer was added or (ii) asymmetrically (e.g., directionally) such that the buffer increases or decreases the size of the geofence 514 in specific directions or at specific points.

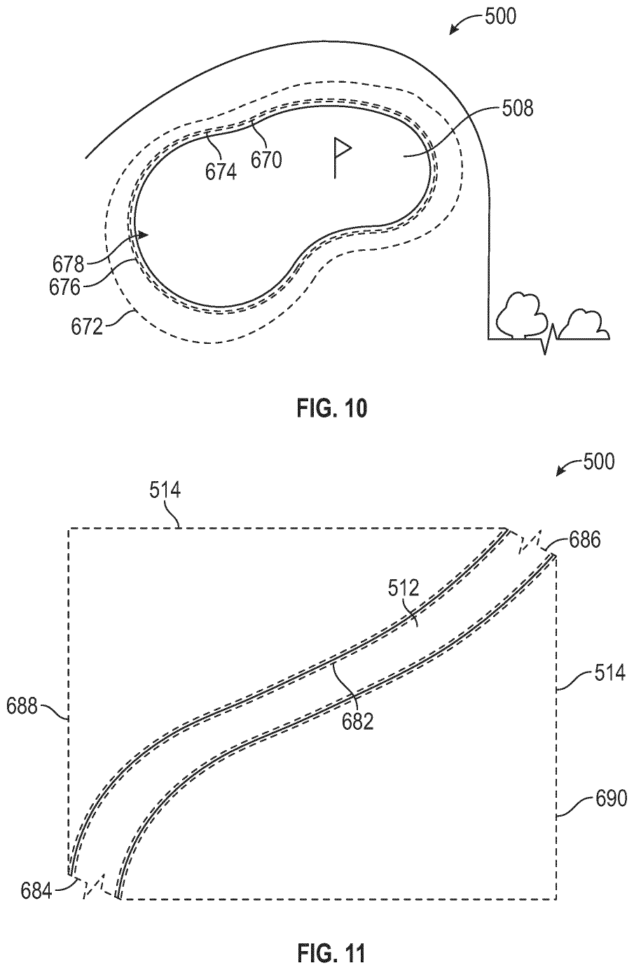

As shown in FIG. 10, a green geofence (e.g., a geofence 514), shown as first geofence 670, is established around the green 508 of the golf course 500, and a surrounding geofence (e.g., a buffer geofence, a donut geofence, an annulus geofence, a geofence 514, etc.), shown as second geofence 672, is established around the first geofence 670. The first geofence 670 may be established using the geofence establishing menu 604 as discussed in greater detail above. The second geofence 672 may be a buffer geofence (e.g., a buffer, a margin, etc.) added to an outer perimeter, shown as perimeter 674, of the first geofence 670 to increase the size of the first geofence 670. In such embodiments, the second geofence 672 is added as a buffer around the first geofence 670 based on the input to the geofence buffer element 664.

As shown in FIG. 9, the geofence editor menu 660 includes a geofence fill and surround element, shown as feature select element 666, configured to facilitate adding a new geofence 514 relative to an existing geofence 514. In some embodiments, the feature select element 666 facilitates establishing the new geofence 514 (e.g., the second geofence 672) around the existing geofence 514 (e.g., the first geofence 670) such that the new geofence 514 surrounds the existing geofence 514. By way of example, the user may select the first geofence 670 (e.g., an existing geofence 514) on the golf course view panel 608 and select a surround button of the feature select element 666 to establish the second geofence 672 (e.g., the new geofence 514) that surrounds the perimeter 674 of the first geofence 670. In such an example, and with reference to FIG. 10, the second geofence 672 may be automatically established (e.g., shaped, sized, positioned, etc.) such that an interior perimeter, shown as inner perimeter 676, of the second geofence 672 is complementary to (e.g., matches, corresponds to, etc.) and extends along the perimeter 674 of the first geofence 670. In some embodiments, the feature select element 666 facilitates establishing a new geofence 514 (e.g., the first geofence 670) within an existing geofence 514 (e.g., the second geofence 672) such that the new geofence 514 fills the existing geofence 514. By way of example, the user may select the second geofence 672 (e.g., the existing geofence 514) defining an annulus shape (e.g., ring shaped) having an interior area (e.g., hole), shown as inner area 678, where the second geofence 672 is not established and select a fill button of the feature select element 666 to establish the first geofence 670 (e.g., the new geofence 514) that fills the inner area 678 of the first geofence 670. In such an example, the first geofence 670 is automatically established (e.g., shaped, sized, positioned, etc.) such that the perimeter 674 thereof is complementary to (e.g., matches, corresponds to, etc.) and extends along the inner perimeter 676 of the second geofence 672.

As shown in FIG. 9, the geofence editor menu 660 includes a first add geofence element, shown as restricted area detection element 668, configured to facilitate adding a geofence 514 when a restricted area is detected within an existing geofence 514. As shown in FIG. 10, the second geofence 672 may be established on the golf course 500 surrounding the green 508 using the geofence establishing menu 604 as discussed in greater detail above. In some embodiments, the fleet monitoring and control system 200 is configured to determine, based on the location of the second geofence 672 relative to the green 508, that the green 508 is positioned within the inner area 678 of the second geofence 672. Based on the determination, the fleet monitoring and control system 200 is configured to suggest adding a geofence (e.g., the first geofence 670) to fill the inner area 678. In such embodiments, the first geofence 670 is established in response to an input to the restricted area detection element 668 approving the suggestion by the fleet monitoring and control system 200. By way of example, in response to (i) a determination by the fleet monitoring and control system 200 that the second geofence 672 is established around the green 508 and that there is not an existing geofence 514 surrounding the green 508, and (ii) an approval of a suggestion to fill the second geofence 672 with the first geofence 670, the first geofence 670 may be automatically established (e.g., shaped, sized, positioned, etc.) such that the perimeter 674 thereof is complementary to (e.g., matches, corresponds to, etc.) and extends along the inner perimeter 676 of the second geofence 672. In some embodiments, the first geofence 670 is established (e.g., shaped, sized, positioned, etc.) based on boundaries of the second geofence 672. By way of example, the boundaries of the first geofence 670 may be automatically established based on the inner perimeter 676 of the second geofence 672 such that the perimeter 674 thereof is complementary to and extends along the inner perimeter 676. By way of another example, the fleet monitoring and control system 200 may be configured to automatically detect the boundaries of the restricted area (e.g., the green 508) based on map data, vision data (e.g., satellite imagery, sensor data from the sensors 90 such as cameras, optical sensors, image recognition, machine vision, machine learning, artificial intelligence, etc.), etc. and automatically establish the first geofence 670 such that the perimeter 674 thereof is complementary to and extends along the detected boundaries of the restricted area.

In some embodiments, the second geofence 672 is integrally formed with the first geofence 670 as a single geofence. In some embodiments, the new geofence 514 (e.g., the first geofence 670 or the second geofence 672) has the same settings as the existing geofence 514 (e.g., the other one of the first geofence 670 or the second geofence 672). By way of example, in response to the vehicle 10 operating within the second geofence 672 (e.g., the second geofence 672 added as a buffer using the geofence buffer element 664, the second geofence 672 added to surround the first geofence 670 using the feature select element 666, etc.), the fleet monitoring and control system 200 controls the operation of the vehicle 10 in the same manner (e.g., limits operation of the vehicle 10 to the second mode of operation) as if the vehicle 10 were operating within the first geofence 670 to which the second geofence 672 was added. In other embodiments, the new geofence 514 has different settings than the existing geofence 514. By way of example, in response to the vehicle 10 operating within the second geofence 672 (e.g., the second geofence 672 added as a buffer using the geofence buffer element 664, the second geofence 672 added to surround the first geofence 670 using the feature select element 666, etc.), the fleet monitoring and control system 200 provides an alert to the operator of the vehicle 10 regarding the first geofence 670 (e.g., a location of the first geofence 670, an indication that the vehicle 10 is operating near the first geofence 670), and, in response to the vehicle 10 operating within the first geofence 670, the fleet monitoring and control system 200 limits operation of the vehicle 10 to the second mode of operation. Although the first geofence 670 is shown established around a green 508 of the golf course 500, it should be understood that the first geofence 670 and the second geofence 672 may be established around any area of the golf course 500 (e.g., a restricted area) and the other one of the first geofence 670 or the second geofence 672 may be established relative thereto.

As shown in FIG. 9, the geofence editor menu 660 includes a passthrough element, shown as geofence passthrough element 680, configured to facilitate adding a passthrough feature to a geofence 514 such that the vehicle 10 can navigate through the geofence 514 without the operation of the vehicle 10 being unintentionally limited. As shown in FIG. 11, a respective geofence 514 is established around a portion of the cart path 512. The fleet monitoring and control system 200 is configured to determine, based on the location of the respective geofence 514 relative to the cart path 512, that the respective geofence 514 overlaps a portion of the cart path 512. Based on the determination, the fleet monitoring and control system 200 is configured to suggest adding a geofence (e.g., a geofence 514, a cart path geofence, etc.), shown as passthrough geofence 682, surrounding the portion of the cart path 512 overlapped by the geofence 514. The passthrough geofence 682 may be established in response to an input to the geofence passthrough element 680 approving the suggestion by the fleet monitoring and control system 200.

In some embodiments, the passthrough geofence 682 is established (e.g., shaped, sized, positioned, etc.) based on boundaries of the cart path 512. By way of example, the boundaries of the cart path 512 may be determined based on an input to the golf course view panel 608 by the user identifying the boundaries and the passthrough geofence 682 may extend along the identified boundaries of the cart path 512. In such an example, the user may draw a line on the golf course view panel 608 along the cart path 512, and the fleet monitoring and control system 200 may create a passthrough geofence 682 along the drawn line. The fleet monitoring and control system 200 may add a buffer to either side of the drawn line, with a width of the passthrough geofence 682 being substantially equal to a width of the cart path 512, thereby establishing the boundaries of the cart path 512 to establish the boundaries of the passthrough geofence 682. By way of another example, the fleet monitoring and control system 200 may be configured to automatically detect the boundaries of the cart path 512 based on map data, image data, sensor data (e.g., from the sensors 90), etc. (e.g., using machine vision, machine learning, artificial intelligence, etc.), and the passthrough geofence 682 may extend along the detected boundaries of the cart path 512.

As shown in FIG. 11, the user can provide an input to the golf course view panel 608 identifying gates, shown as entry gate 684 and exit gate 686, along a boundary of a respective geofence 514, and the passthrough geofence 682 is established though the respective geofence 514 from the entry gate 684 to the exit gate 686. In such an example, the vehicle 10 may enter the passthrough geofence 682 through the entry gate 684 of the respective geofence 514 and exit the passthrough geofence 682 through the exit gate 686 of the respective geofence 514 to navigate through the respective geofence 514 without the operation thereof being limited.

As shown in FIG. 11, in response to the passthrough geofence 682 being established, the fleet monitoring and control system 200 segments (e.g., splits, separates, etc.) the geofence 514 into one or more geofence portions, shown as first geofence portion 688 and second geofence portion 690. The first geofence portion 688 and the second geofence portion 690 extend along the passthrough geofence 682 and define boundaries complementary to (e.g., matching, corresponding to, etc.) boundaries of the passthrough geofence 682.

According to an exemplary embodiment, adding the passthrough geofence 682 helps facilitate avoiding unintentionally establishing keep-out geofences around portions of drivable areas, and thereby unintentionally limiting operation of the vehicle 10 when the vehicle 10 is operating within the drivable areas. By way of example, the user may (i) configure a respective geofence 514 such that the respective geofence 514 is a keep-out geofence (e.g., operation of the vehicle 10 is limited to the second mode of operation when the location is within the keep-out geofence), and (ii) establish the respective geofence 514 around the cart path 512. In such an example, the fleet monitoring and control system 200 may suggest adding a passthrough geofence 682 through the respective geofence 514 and surrounding the cart path 512 such that operation of the vehicle 10 is permitted in the first mode of operation when the vehicle 10 is operating within the passthrough geofence 682 (the operation of the vehicle 10 that would otherwise be limited if the passthrough geofence 682 were not added). Further, adding the passthrough geofence 682 increases the efficiency of creating geofences 514 along drivable areas such as the cart path 512 because the fleet monitoring and control system 200 may be configured to automatically create the passthrough geofence 682 instead of the user being required to create two separate geofences along the sides of the drivable area and a third geofence surrounding the drivable area. While the passthrough geofence 682 is described above with reference to the cart path 512, it should be understood that the passthrough geofence 682 may be established around any other drivable area of the golf course 500 in response to a determination by the fleet monitoring and control system 200 that a respective geofence 514 overlaps at least a portion of the drivable area.

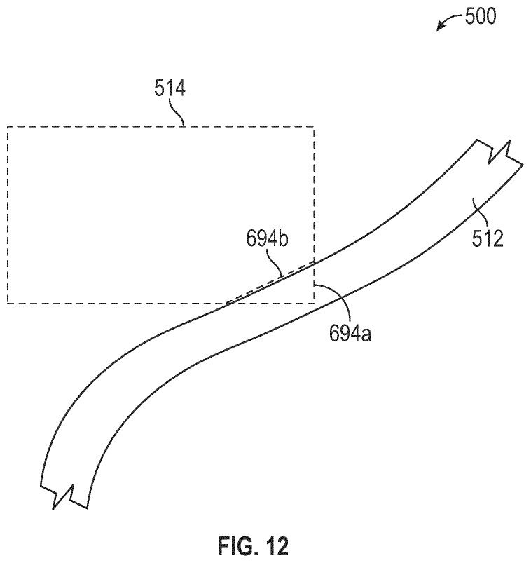

As shown in FIG. 9, the geofence editor menu 660 includes a second add geofence element, shown as drivable area detection element 692, configured to edit a boundary of a respective geofence 514 (e.g., a perimeter of the geofence 514) when a drivable area is detected within the respective geofence 514. As shown in FIG. 12, a respective geofence 514 is established around a portion of the cart path 512. Specifically, a portion of the boundary of the respective geofence 514, shown as boundary 694a, overlaps a portion of the cart path 512. The fleet monitoring and control system 200 is configured to determine, based on the location of the respective geofence 514 relative to the cart path 512, that the boundary 694a overlaps the portion of the cart path 512. Based on the determination, the fleet monitoring and control system 200 is configured to suggest a new boundary of the respective geofence 514, shown as boundary 694b, such that the respective geofence 514 does not overlap the cart path 512. The boundary 694a may be transitioned to the boundary 694b in response to an input to the drivable area detection element 692 approving the suggestion (e.g., the suggested boundary 694b) by the fleet monitoring and control system 200. In some embodiments, the suggested boundary 694b is suggested and established (e.g., shaped, sized, positioned, etc.) based on boundaries of the cart path 512. By way of example, the boundaries of the cart path 512 may be determined based on an input to the golf course view panel 608 by the user identifying the boundaries and the boundary 694b may extend along the identified boundaries of the cart path 512. By way of another example, the fleet monitoring and control system 200 may be configured to automatically detect the boundaries of the cart path 512 based on map data, image data, sensor data (e.g., from the sensors 90), etc. (e.g., using machine vision, machine learning, artificial intelligence, etc.), and the boundary 694b may extend along the detected boundaries of the cart path 512. While the boundary 694b is described above with reference to the cart path 512, it should be understood that the boundary 694b may be suggested and established based on the boundaries of any other drivable area of the golf course 500 in response to a determination by the fleet monitoring and control system 200 that a respective geofence 514 overlaps at least a portion of the drivable area.

As utilized herein with respect to numerical ranges, the terms “approximately,” “about,” “substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle control system 100, etc.) and the fleet monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

1. A golf course management system comprising:
one or more processing circuits configured to:
provide a graphical user interface on a user device, the graphical user interface including a restricted operation area feature that facilitates establishing one or more restricted operation areas within a respective area based on a user input received from the user device;
establish a first restricted operation area around a first area of the respective area; and
establish a second restricted operation area around a second area of the respective area, the second restricted operation area surrounding the first restricted operation area;
wherein the first restricted operation area or the second restricted operation area is established based on the user input to the user device; and
wherein the other one of the first restricted operation area or the second restricted operation area is established based on a location of the first restricted operation area or the second restricted operation area.

2. The golf course management system of claim 1, wherein the one or more processing circuits are configured to:
establish the second restricted operation area based on the user input to the user device; and
automatically establish the first restricted operation area based on the location of the second restricted operation area such that the first restricted operation area fills at least a portion of an inner area of the second restricted operation area.

3. The golf course management system of claim 1, wherein the one or more processing circuits are configured to:
establish the first restricted operation area based on the user input to the user device; and
automatically establish the second restricted operation area based on the location of the first restricted operation area such that the second restricted operation area surrounds the first restricted operation area.

4. The golf course management system of claim 1, wherein the second restricted operation area surrounds the first restricted operation area such that an inner perimeter of the second restricted operation area is complementary to a perimeter of the first restricted operation area.

5. The golf course management system of claim 1, wherein the one or more processing circuits are configured to adjust at least one of a size or a shape of the first restricted operation area or the second restricted operation area based on the user input to the user device.

6. The golf course management system of claim 5, wherein the user input is indicative of a buffer to the first restricted operation area or the second restricted operation area, and wherein the one or more processing circuits are configured to increase or decrease the size of the first restricted operation area or the second restricted operation area according to the buffer.

7. The golf course management system of claim 1, wherein the respective area includes a drivable area, wherein the one or more processing circuits are configured to:
determine that at least one of the first restricted operation area or the second restricted operation area is established within the drivable area; and
modify or suggest modifying the first restricted operation area or the second restricted operation area to be outside of the drivable area.

8. The golf course management system of claim 1, wherein the first restricted operation area is defined by a first geofence and the second restricted operation area is defined by a second geofence.

9. The golf course management system of claim 1, wherein the one or more processing circuits are configured to:
monitor a location of a golf vehicle relative to the respective area; and
control operation of the golf vehicle based on the location of the golf vehicle relative to the first restricted operation area and the second restricted operation area.

10. The golf course management system of claim 9, wherein the one or more processing circuits are configured to:
limit operation of the golf vehicle when the location indicates that the golf vehicle is located in the first restricted operation area or the second restricted operation area; and
permit operation of the golf vehicle when the location indicates that the golf vehicle is located in the first restricted operation area or the second restricted operation area in response to a determination that the golf vehicle entered the first restricted operation area or the second restricted operation area through a gate established along the first restricted operation area or the second restricted operation area.

11. The golf course management system of claim 9, wherein the golf vehicle is one of a golf cart, an all-terrain vehicle, a utility task vehicle, a low speed vehicle, a lightweight or recreational vehicle, a lawnmower, a turf mower, a push mower, a ride-on mower, a stand-on mower, an aerator, a turf sprayer, or a bunker rake.

12. The golf course management system of claim 1, wherein the one or more processing circuits are configured to:
monitor locations of a plurality of golf vehicles relative to the respective area, the plurality of golf vehicles including a first golf vehicle and a second golf vehicle;
permit unrestricted operation of the first golf vehicle when the location indicates that the first golf vehicle is located in the second restricted operation area; and
limit operation of the second golf vehicle or warn an operator of the second golf vehicle when the location indicates that the second golf vehicle is located in the second restricted operation area.

13. The golf course management system of claim 1, wherein the respective area includes a drivable area, and wherein the one or more processing circuits are configured to:
determine (i) the location of the first restricted operation area or the second restricted operation area and (ii) a location of the drivable area;
determine that at least one of the first restricted operation area or the second restricted operation area overlaps at least a portion of the drivable area based on the location of the first restricted operation area or the second restricted operation area relative to the location of the drivable area; and
adjust or suggest adjusting a first boundary of the first restricted operation area or the second restricted operation area to extend along a second boundary of the drivable area such that the first restricted operation area or the second restricted operation area does not overlap the drivable area.

14. A golf course management system comprising:
one or more processing circuits configured to:
provide a graphical user interface on a user device, the graphical user interface including a restricted operation area feature that facilitates establishing a restricted operation area within a respective area based on a user input received from the user device;
establish the restricted operation area around a first area of the respective area based on the user input;
determine that the restricted operation area is established around or at least partially along a cart path of the respective area; and
modify or suggest modifying the restricted operation area such that the restricted operation area does not overlap the cart path.

15. The golf course management system of claim 14, wherein the one or more processing circuits are configured to:
receive vision data of the respective area; and
determine that the restricted operation area is established around the cart path based on the vision data.

16. The golf course management system of claim 14, wherein modifying the restricted operation area such that the restricted operation area does not overlap the cart path includes segmenting the restricted operation area into a first portion and a second portion, and wherein the first portion and the second portion extend along the cart path and define boundaries complementary to boundaries of the cart path.

17. The golf course management system of claim 14, wherein modifying the restricted operation area such that the restricted operation area does not overlap the cart path includes adjusting a first boundary of the restricted operation area to extend along a second boundary of the cart path.

18. The golf course management system of claim 14, wherein the restricted operation area is a first restricted operation area, and wherein the one or more processing circuits are configured to:
establish a second restricted operation area around a second area of the respective area, the second restricted operation area surrounding the first restricted operation area;
wherein the first restricted operation area or the second restricted operation area is established based on the user input to the user device; and
wherein the other one of the first restricted operation area or the second restricted operation area is established based on a location of the first restricted operation area or the second restricted operation area.

19. A golf course management system comprising:
one or more processing circuits configured to:
provide a graphical user interface on a user device, the graphical user interface including a map of a respective area and including a restricted operation area feature that facilitates establishing one or more restricted operation areas on the map based on a user input received from the user device;
establish a restricted operation area around a first area of the respective area;
determine (i) a location of the restricted operation area and (ii) a location of a drivable area on the map;
determine that the restricted operation area overlaps at least a portion of the drivable area based on the location of the restricted operation area relative to the location of the drivable area; and
adjust or suggest adjusting a boundary of the restricted operation area to extend along a boundary of the drivable area such that the restricted operation area does not overlap the drivable area.

20. The golf course management system of claim 19, wherein the restricted operation area is a first restricted operation area, and wherein the one or more processing circuits are configured to:
establish a second restricted operation area around a second area of the respective area, the second restricted operation area surrounding the first restricted operation area;
wherein the first restricted operation area or the second restricted operation area is established based on the user input to the user device; and
wherein the other one of the first restricted operation area or the second restricted operation area is established based on a location of the first restricted operation area or the second restricted operation area.
